(19) United States
(12) Patent Application Publication
(10) Pub. No.: US 2008/0179250 A1
(43) Pub. Date: Jul. 31, 2008

(54) EXTENDED-LIFE WATER SOFTENING SYSTEM, APPARATUS AND METHOD

(76) Inventors: Harapanahalli S. Muralidhara, Plymouth, MN (US); N.S. Krishna Kumar, Savage, MN (US)

Correspondence Address: PERKINS COIE LLP, POST OFFICE BOX 1208, SEATTLE, WA, 98111-1208, US

(21) Appl. No.: 12/013,386

(22) Filed: Jan. 11, 2008

Related U.S. Application Data
(63) Continuation of application No. PCT/US2006/026812, filed on Jul. 11, 2006.
(60) Provisional application No. 60/698,652, filed on Jul. 12, 2005.

(51) Int. Cl. B01D 61/02

(52) U.S. Cl. 210/652

(57) ABSTRACT

An apparatus and methods for softening water is disclosed. In particular, an apparatus and method for softening water without the addition of ions the wastewater stream is disclosed. The apparatus generally includes at least one nanofiltration filter element configured and arranged to receive an input flow of hard water, discharge an output flow of permeate water comprising a portion of the input flow, and discharge an output flow of non-permeate water comprising a portion of the input flow. The nanofiltration filter element typically has an average pore size that permits the passage of water and monovalent ions but substantially prevents the passage of divalent ions.

### CROSS-REFERENCE TO RELATED APPLICATIONS

This application is a continuation of PCT International Patent Application No. PCT/US2006/026812 filed on Jul. 11, 2006, and published in English on Jan. 18, 2007 as publication No. WO 2007/008850, which claims priority to U.S. Provisional Patent Application No. 60/698,652, filed on Jul. 12, 2005, both of which are incorporated herein in their entirety by reference, including drawings.

### FIELD OF THE INVENTION

The present invention is directed to methods and systems for treating water. In particular, the invention is directed to methods and systems for softening potable water, and to methods and systems for extending the operation of water softening systems, in particular to methods and systems that remove ions from potable water with lower water loss than conventional softening systems.

### BACKGROUND OF THE INVENTION

Water containing high levels of calcium and magnesium ions is called “hard water” because these two ions can combine with other ions and compounds to form a hard, unattractive scale. Millions of homes have hard water supplies, particularly homes that use groundwater as their water source, either through a residential well or as part of municipal water supply. Hard water can result in formation of an unattractive film around sinks and dishes, and hard water deposits can form on clothing, resulting in discoloration and reduced fabric softness. Also, some soaps and detergents do not work as well with hard water as with soft water. In such situations, uncomfortable or unsightly soap films can be left behind on the person or object being washed.

Approximately 7 to 12 percent of all private homes have water softeners. The rate of water softener use is higher in rural areas than in cities, with an estimated 3 percent of urban dwellers using a water softener. An estimated one million ion exchange water softeners are sold each year in the United States alone, and hundreds of millions of dollars is spent on salt. The majority of these softeners are installed in homes and small businesses that acquire their water supplies from groundwater.

Although ion exchange softeners are suitable for many applications, they have significant limitations. In particular, ion exchange water-softening results in a net increase in the salinity of discharged water because of the brine discharge. This net increase in discharge salinity can be problematic in areas where anti-brine discharge regulations are in place. These regulations often exist in localities that reuse discharged water for agricultural purposes and which wish to avoid adding excess salt to land on which the discharged water is applied. In addition, ion exchange softeners require regular replacement of the sodium salts for recharging the resin, and maintenance costs associated with the purchase of the salt.

In view of the significant problems associated with hard water, as well as the limitations of ion exchange water softeners, recent developments have been made in the creation of water softeners that use nanofiltration elements to soften residential water at relatively low pressures and with high efficiency. U.S. patent application Ser. No. 09/909,488, entitled Nanofiltration Water-Softening Apparatus and Method to Muralidhara et al, is particularly noteworthy in this regard. However, despite significant recent advances in softening technology, a need remains for improved methods and systems for softening water using nanofiltration filter elements, in particular a need remains for even longer-life membrane elements requiring less frequent membrane replacement.

### SUMMARY OF THE INVENTION

Some embodiments of the present invention are directed to methods, and systems for softening water, in particular to methods and systems for softening water without the addition of ions to the wastewater stream. The systems use nanofiltration filter elements to selectively remove hardness ions, in particular large ions (such as the divalent ions of calcium and magnesium), in order to soften the water without adding salt to the wastewater stream.

In addition, other embodiments of the present invention provide methods and systems for extending the operating life of nanofiltration filter elements used within the softening systems, and also methods and systems for improving the performance of the softening systems. These methods and systems are particularly useful for multi-element nanofiltration systems having one, two, and more typically, three or more, nanofiltration elements assembled in series. In these nanofiltration softening systems, potable water enters a first nanofiltration element and is divided into softened permeate water flow and a concentrate flow of water containing retained calcium and magnesium ions. The softened permeate water flow is diverted for use, while the concentrate water flow from the first membrane is delivered to a second nanofiltration element. At the second nanofiltration element the concentrate water from the first nanofiltration element is again divided into a softened permeate flow and a concentrate flow containing retained calcium and magnesium ions. In a three element system, the concentrate flow from the second nanofiltration element is delivered to a third nanofiltration element, where it is again separated into a softened permeate water flow and a concentrate flow of water containing retained calcium and magnesium ions.

The use of multiple nanofiltration elements can be advantageous because it allows for more efficient water usage, thereby resulting in less water being discharged into a wastewater stream. However, each subsequent nanofiltration element receives increasingly high concentrations of calcium and magnesium. This can result in various problems, most notably fouling of the membranes with calcium and magnesium precipitates. Thus, for example, in a three-element system, the third element can experience significant calcium precipitation on the surface of the membrane in the nanofiltration element, thereby significantly reducing membrane flux. In some circumstances this precipitation can result in fouling of the membranes to an extent that the nanofiltration elements must be prematurely replaced.

As noted above, some embodiments of the present invention provide methods and systems for extending the operating life of nanofiltration filter elements used within softening systems, and also methods and systems for improving the performance of the softening systems. These methods and systems are particularly useful for multi-element nanofiltration systems having one, two, and more typically, three or more, nanofiltration elements assembled in series. Among these improvements are methods for periodically reversing the flow of water through the nanofiltration softening system, thereby reducing scaling and fouling of membranes. In addition, said embodiments provide for a flushing mode of operation in which each of the nanofiltration membranes is flushed with potable water to remove excess calcium and magnesium from the nanofiltration elements. In certain embodiments, this flushing includes using a mild acid to dissolve calcium and magnesium precipitates within the nanofiltration elements. These precipitates are then removed from the system and discarded in the wastewater stream.

Some embodiments of the present invention provide various improvements over prior softening systems, including having consistent soft water that can have reduced levels of bacteria and pyrogens relative to ion exchange softening. Furthermore, it requires no need to add salt to the water supply, thereby being more environmentally friendly.

The nanofiltration filter elements typically have an average pore size that permits the passage of water and most monovalent ions, but substantially prevents the passage of most divalent ions. Thus, the softening apparatus does not add ions to the water stream, but rather removes at least some of the ions from the input flow and discharges them into the discarded non-permeate output flow. Various different nanofiltration filter elements are suitable for use with the invention, including filter elements that contain a positively charged membrane.

The above summary of some embodiments of the present invention is not intended to describe each disclosed embodiment or every implementation of the present invention. The Figures and the detailed description which follow more particularly exemplify these embodiments.

### FIGURES

Embodiments of the present invention are set forth in the following description and are shown in the drawings. Similar numerals refer to similar parts throughout the drawings.

FIG. 1 shows a simplified schematic design of a nanofiltration water softening system made in accordance with an implementation of the invention, the nanofiltration system containing three nanofiltration elements.

FIG. 2 shows a simplified schematic design of a nanofiltration water softening system made in accordance with an implementation of the invention, the nanofiltration system containing three nanofiltration elements, the system being operated with standard forward flow of feed water.

FIG. 3 shows a simplified schematic design of the operation of the nanofiltration water softening system shown in FIG. 2, the system being operated with reverse flow of feed water.

FIG. 4 shows a simplified schematic design of a nanofiltration water softening system made in accordance with an implementation of the invention, the system being operated in flush mode with a water flow bypass.

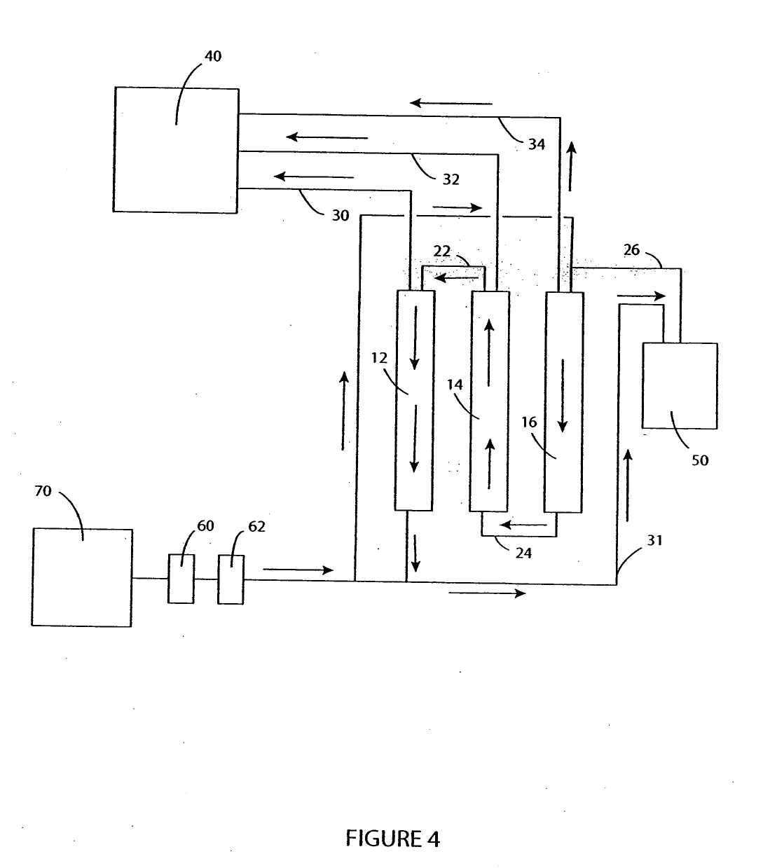

FIG. 5 shows a simplified schematic design of a nanofiltration water softener made in accordance with an implementation of the invention, the system configured for, and operated with, an acid flush mode to remove precipitates from the nanofiltration elements.

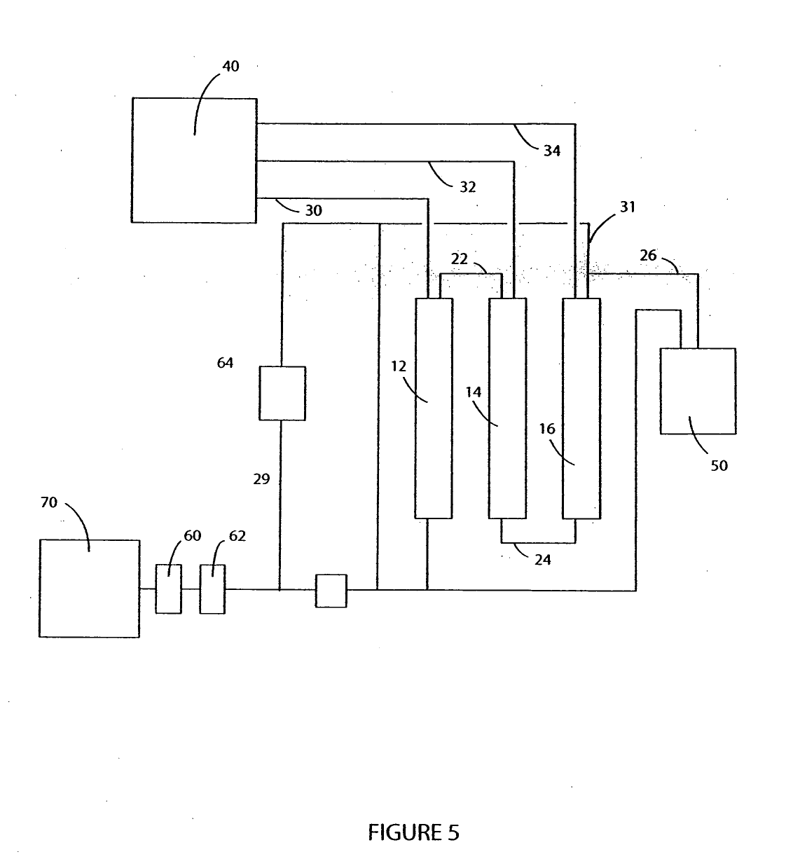

FIG. 6 is a graph indicating the effect of acid washing on the flux of the water softening system.

FIG. 7 is a graph indicating the effect of flushing the nanofiltration elements on flux of water through the softening system.

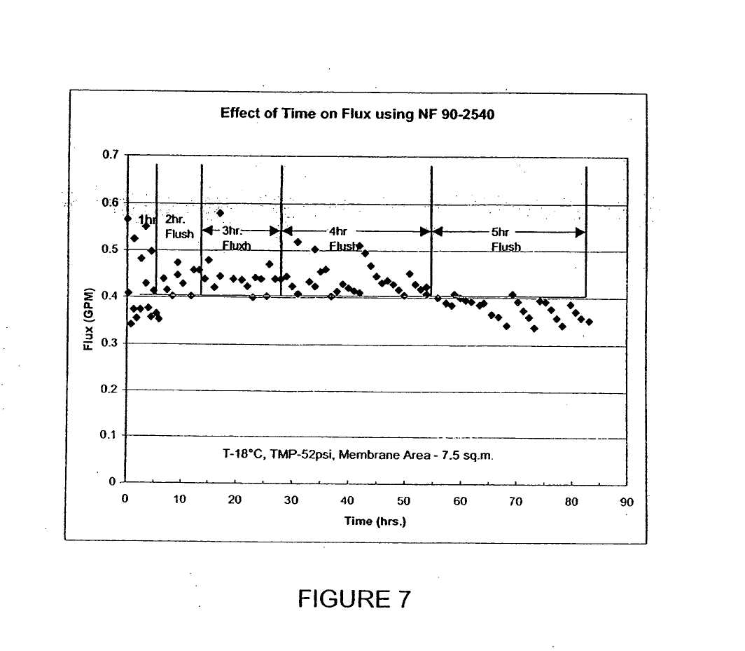

FIG. 8 is a graph indicating the effect of flushing and flow reversal on flux of water through the softening system.

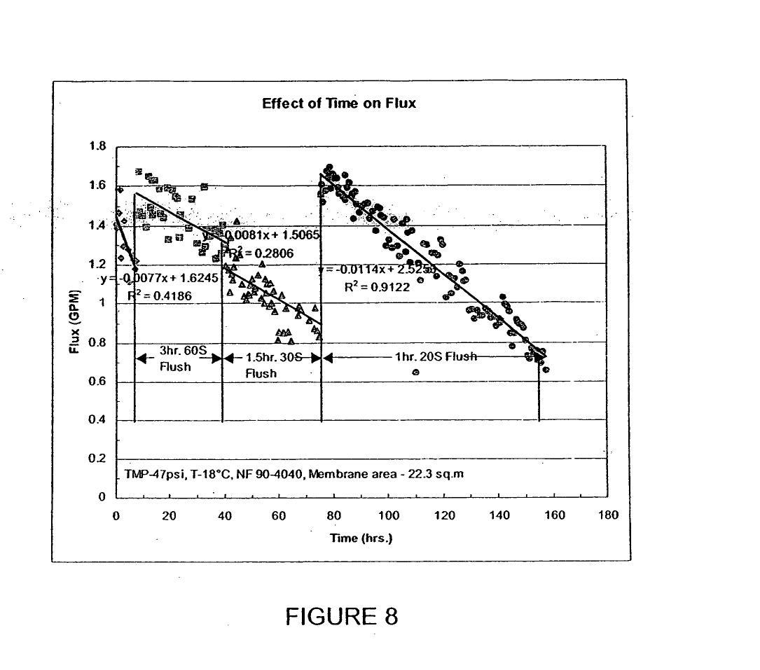

FIG. 9 shows the effect of acid washing on flux of water through the softening system.

FIG. 10 shows the effect of time on permeate flux and rejection.

FIG. 11 shows the effect of time on permeate flux and hardness.

FIG. 12 shows the effect of time on permeate flux for a boiler feed.

FIG. 13 shows the effect of time on permeate flux and hardness.

FIG. 14 shows the effect of time on permeate flux and rejection is shown.

### DETAILED DESCRIPTION OF PREFERRED EMBODIMENTS

The following description of the invention is intended to illustrate various embodiments of the invention. As such, the specific modifications discussed are not to be construed as limitations on the scope of the invention. It will be apparent to one skilled in the art that various equivalents, changes, and modifications may be made without departing from the scope of the invention, and it is understood that such equivalent embodiments are to be included herein.

In one embodiment of the present invention an apparatus and method for softening water, in particular to apparatus and methods for softening water without the addition of ions to the wastewater stream is provided. The present embodiment provides methods and systems for extending the operating life of nanofiltration filter elements used within the softening systems, and also methods and systems for improving the performance of the softening systems. Among these improvements are methods for periodically reversing the flow of water through the nanofiltration softening system, thereby avoiding scaling and fouling of membranes.

In addition, the present embodiment provides for a flushing mode of operation in which each of the nanofiltration membranes is flushed with potable water to remove excess calcium and magnesium from the nanofiltration elements. In certain embodiments, this flushing include uses a mild acid to dissolve any calcium and magnesium precipitates, which are then removed from the system and discarded in the wastewater stream.

The present embodiment provides methods and systems for extending the operating life of nanofiltration filter elements used within the softening systems, and also methods and systems for improving the performance of the softening systems. These methods and systems are particularly useful for multi-element nanofiltration systems having at least one, frequently two, and more typically three or more, nanofiltration elements assembled in series. In these nanofiltration softening systems, potable water enters a first nanofiltration element and is divided into softened permeate water flow and a concentrate flow of water containing retained calcium and magnesium ions.

The softened permeate water flow is diverted for use, while the concentrate water from the first nanofiltration element is delivered to a second nanofiltration element. At the second nanofiltration element the concentrate water from the first nanofiltration element is again divided into a softened permeate flow and a concentrate flow containing retained calcium and magnesium ions. In a three element system, the concentrate from the second nanofiltration element is delivered to a third nanofiltration element, where it is again separated into a softened permeate water flow and a concentrate flow of water containing retained calcium and magnesium ions.

Having multiple nanofiltration elements is advantageous because it allows a higher efficiency of water usage, thereby typically resulting in less water being discharged into a wastewater stream. Each subsequent nanofiltration element receives increasingly high concentrations of calcium and magnesium. This can result in various problems, most notably fouling of the membranes with calcium and magnesium precipitates. Thus, for example, in a three-element system, the third element can experience significant calcium precipitation on the surface of the membrane in the nanofiltration element, thereby dramatically reducing flow. In some circumstances this precipitation can result in fouling of the membrane to an extent that they must be prematurely replaced.

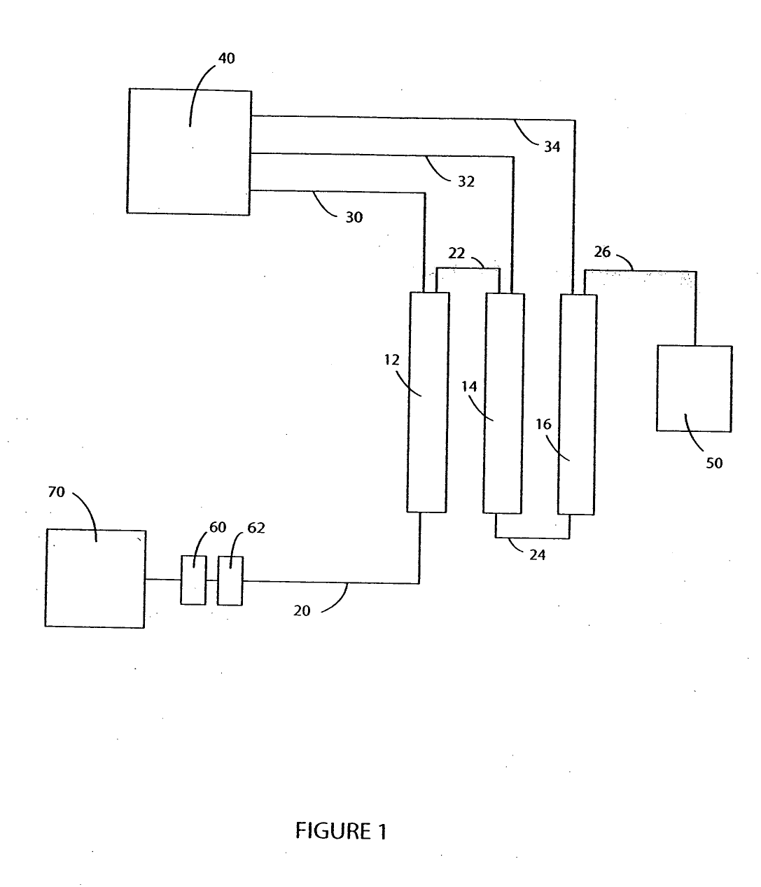

A generalized schematic diagram of a first implementation of the invention is shown in FIG. 1. System 10, shown in FIG. 1, includes three nanofiltration elements 12, 14, and 16 connected in series. As noted above, systems made in accordance with the present invention can include more or fewer than three nanofiltration elements. Thus, for example, in some implementations the system 10 includes just two nanofiltration elements, while in other implementations the system 10 includes, four, five, or more elements. Also, certain aspects of the invention, such as flushing the nanofiltration element with a low-pH solution, are suitable for use with even just one nanofiltration element.

System 10 of FIG. 1 includes a supply 70 of source water, such as water from a residential well or from a municipal source. FIG. 1 and subsequent figures have been simplified for clarity to indicate the primary elements and arrangements of those elements. For example, the system 10 generally includes numerous valves allowing changes in flow directions. Typically these valves are not depicted in the figures but inferred from the description of the water flows.

Water from supply 70 typically first goes through one or more prefilters or treatment steps, such as through a particulate filter 60 and an activated carbon filter 62. These filters 60, 62, while generally optional, can significantly improve the operating life of the nanofiltration elements 12, 14, 16. After passing through prefilters 60, 62, the water travels along conduit 20 (typically a plastic or metal pipe or tube) to enter first nanofiltration element 12. Water entering nanofiltration element 12 is separated into two flows: a permeate flow of softened water and a concentrate flow of unsoftened water, this concentrate flow having a higher hardness than the water that entered the nanofiltration element 12. The permeate flow exits the nanofiltration element 12 and is diverted by conduit 30 to either a holding tank 40 or can be directly delivered for end use, such as by being plumbed directly into a residential water supply.

The concentrate flow exits the nanofiltration element 12 and is diverted by conduit 22 to the second nanofiltration element 14. Water entering the second nanofiltration element 14 is again separated into both a permeate flow and a concentrate flow. The permeate flow is diverted by conduit 32 to holding tank 40 or can be directly delivered for end use. Typically permeate flows from conduit 30 and 32 are handled similarly, being delivered to a common holding tank or directly delivered into a water supply. The concentrate flow from nanofiltration element 14 exits the element 1 by way of conduit 24, which delivers the flow to nanofiltration element 16. Nanofiltration element takes this concentrate flow from element 14, which is more concentrated than the concentrate flow from element 12, and delivers it to nanofiltration element 16. Nanofiltration element 16 again separates the incoming flow into two distinct outgoing flows. First is a flow of softened permeate water, which exits element 16 by way of conduit 34, where it is directed into holding tank 40 or otherwise used as softened water. Concentrate flow from nanofiltration element 16 is discharged through conduit 26 to discharge destination 50, which is typically a sanitary sewer line or other wastewater destination.

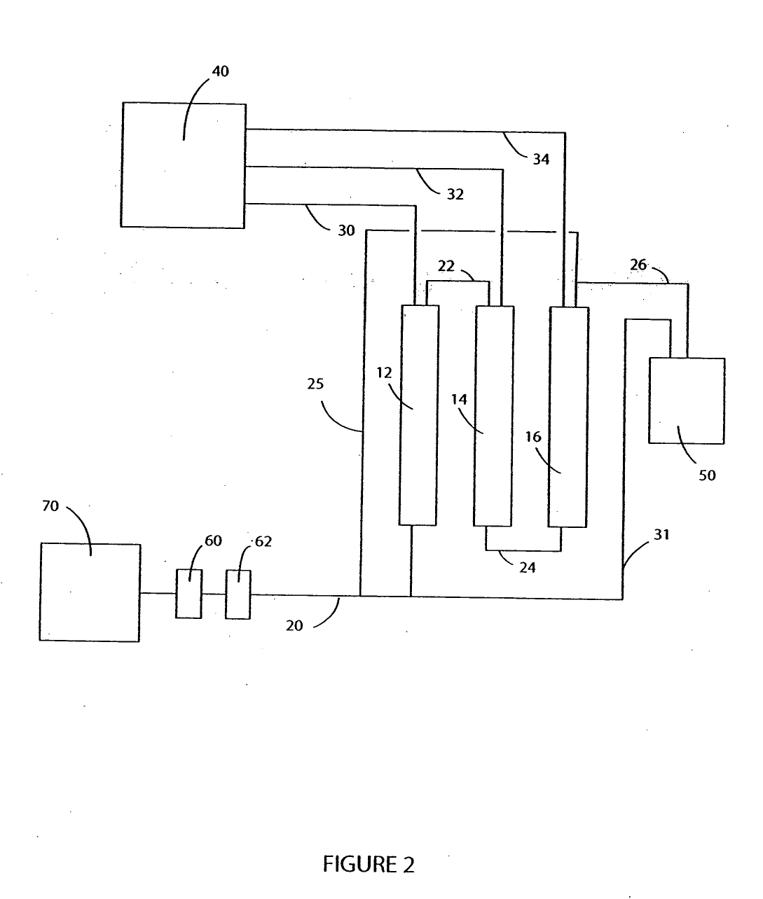

FIG. 2 shows a similar nanofiltration system as that shown in FIG. 1, except the nanofiltration system 10 includes the ability to reverse flow through the nanofiltration elements 12, 14, 16 in order to prevent or reduce the development of salts from precipitating on the nanofiltration elements, especially salts of calcium and magnesium. Arrows depict the direction of water flow within system 10 of FIG. 2. Nanofiltration water softening system 10 includes additional conduit 25 that allows for the flow of water from source 70 up to conduit 26, after which it enters nanofiltration element 16, then nanofiltration element 14, and finally nanofiltration element 12, exits nanofiltration element 12 and is diverted by conduit 27 back to a discharge conduit 31 leading to discharge destination 50. Conduits 34, 32, and 30 continue to remove softened permeate water from the nanofiltration elements, while conduits 24, and 22 connect the nanofiltration elements.

The advantage of operation of the system as shown in FIG. 2 is that it allows cycling of the water flows so that flow is periodically reversed in its order through the membranes. For a first period of time the water flows in a first direction, while in the second period of time the water flows in the opposite direction. This avoids the development of excessive concentrations of calcium and magnesium ions on the final nanofiltration membrane, which results in precipitation of ions onto the membrane. Depending upon feed water characteristics, some precipitates can even be removed from the nanofiltration membrane upon reversal of flow

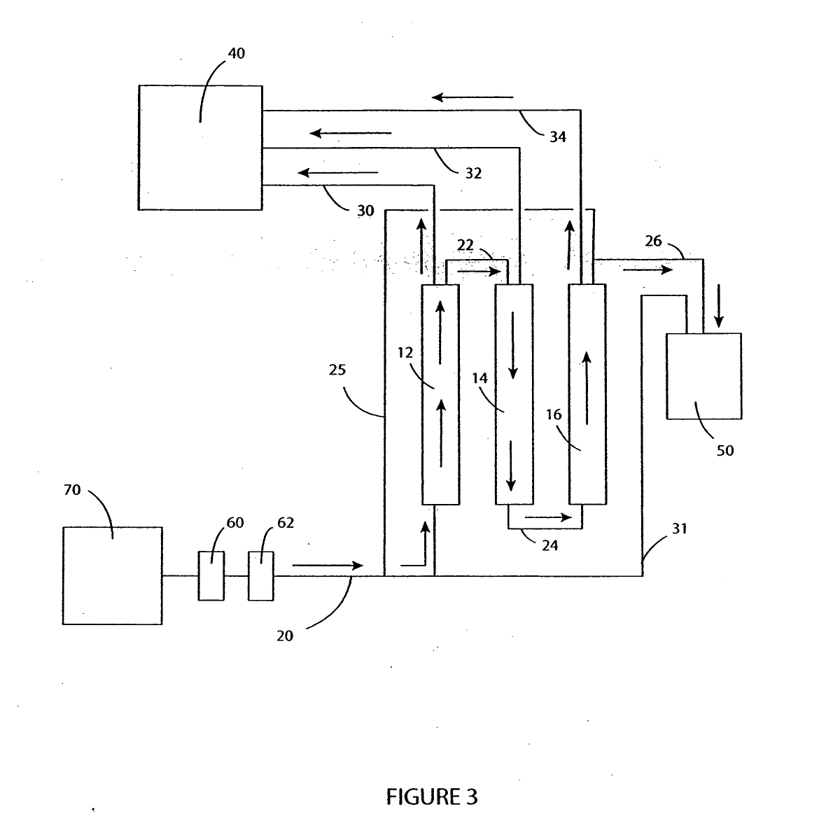

FIG. 3 shows the same nanofiltration softening system as that depicted in FIG. 2, but the order of flow through the nanofiltration elements 12, 14, 16 has been reversed, as shown by the flow arrows.

Various nanofiltration filter elements can be used with the present invention. The filter elements should be suitable for use in softening hard water at relatively low pressures while providing suitably high flow rates and recovery rates. Thus, not all nanofiltration elements provide adequate rejection rates of hardness ions, water flow, and water recovery rates. Suitable nanofiltration elements are described in greater detail below.

The nanofiltration element dimensions are generally selected based upon the application for which it will be used. Thus, the nanofiltration element's length, width, and surface area can all be selected to improve the softening apparatus' suitability for specific uses. Nanofiltration elements come in various configurations; including spiral wound membranes, hollow fibers, and tubular. In general the nanofiltration element is a spiral wound membrane.

The nanofiltration element generally has a surface area of greater than 2.0 square meters but less than 40 square meters, and more typically from 7 to 40 square meters. The nanofiltration elements should not be so long that they require production of a large housing that will not fit in a residence. In general, the nanofiltration elements are selected such that the softening apparatus will fit in the utility area of a home. Suitable elements can have, for example, a total filter length from 40 to 125 centimeters. Nanofiltration elements suitable for use with the invention typically have a diameter of 5 to 25 cm.

Suitable nanofiltration membranes for use with the water-softening apparatus include, for example, the Dow Film Tec NF90, which is a polyamide thin film composite membrane, the Dow Film Tec NF270, which is a polyamide thin film composite membrane, the Dow Film Tec NF 200, which is a polyamide thin film composite, the Trisep TS 83, which is an aromatic polyamide thin film membrane, the Trisep TS 80, which is a aromatic polyamide, and the PTI-AFM NP, which is a polyamide thin film composite, and the Koch Membranes TFC-SR1, a thin film composite polyamide membrane. The NF 90 has demonstrated to be a particularly useful membrane, having solute passage of about 5 to 15 percent, and a flux of 21.4 LMH, with a total hardness of 15 ppm, calcium ion 3 ppm, and magnesium of 2 ppm.

Table 1, below, shows results of using six different membranes and the analysis of permeate and feed water for hardness with municipal water. All experiments were carried out at 70 psi using a flat sheet membrane and at room temperatures.

TABLE 1

| | | Total | | |
|---|---|---|---|---|
| | | Hardness | Calcium | Magnesium |
| Sample | Flux (LMH) | (ppm) | (ppm) | (ppm) |
| Initial Feed | N/A | 182 | 45 | 17 |
| NF 90 | 21.4 | 15 | 3 | 2 |
| NF 270 | 38 | 117 | 32 | 9 |
| NF 200 | 9.5 | 101 | 32 | 5 |
| TRISEP TS | 15.8 | 61 | 16 | 5 |
| 83 | | | | |
| TRISEP TS | 18.8 | 40 | 16 | 0 |
| 80 | | | | |
| PTI-AFM NP | 26.4 | 117 | 32 | 9 |

In general, the nanofiltration elements suitable for use with the invention have a high rejection rate of divalent ions, along with sufficient flow of water through the nanofiltration elements at relatively low pressures in order to provide a water flow rate and recovery rate that is sufficiently high to meet the needs of most residential customers. These divalent ions include numerous hardness ions, such as calcium and magnesium. By flow rate it is meant the average peak flow rate through the filter. By recovery rate, it is meant the percentage of input water that is recovered as softened water, relative to the amount of water that enters the water softener. Although these specific parameters are all individually important, the combination of these parameters is particularly important in order to provide a water softener that is suitable for use in residences and small businesses.

The nanofiltration filter element typically has an average pore size that permits the passage of water and monovalent ions but substantially rejects the passage of divalent ions, in particular divalent ions associated with water hardness. Although various ions can be used to measure rejection rate, one suitable ion for making such determinations is the calcium ion. Typical nanofiltration filter elements useful with the present invention normally restrict greater than 80 percent of the calcium ions from passing through the filter element under operating conditions. More suitable filter elements restrict greater than 85 percent of the calcium ions from passing through the filter under operating conditions. Even more suitable filter elements have a rejection rate of greater than 90 percent of calcium ions. The nanofiltration elements must have sufficient permeate flux of water. For example, in certain embodiments, deionized water flux through the nanofiltration elements is around 30 liters per square meter of filter membrane per hour (Imh) at 30-60 psi.

Suitable nanofiltration elements typically have a molecular weight filtration cut-off diameter of 20 to 500, even more commonly 100 to 400, and most commonly 200 to 300. As used herein, filtration cut-off (expressed in molecular weight) follows the convention used in filtration measurements, and refers to a range of molecular weights of materials that are excluded at high rates. However, generally small quantities of material will pass through such membranes that have molecular weights within the cut-off range. In addition, relatively high rates of exclusion of molecules outside of the cut-off range can occur, but such exclusion is generally at a lower rate than within the cut-off range. By using a filter with a higher molecular weight cut-off it is possible to increase water flow. In this manner the sufficient exclusion of calcium ions, and adequate water passage, occurs with a filtration element having a molecular weight cut-off range of 200 to 300.

The apparatus is advantageously constructed such that it does not substantially increase the total salt levels relative to the input flow of water. Thus, the softening apparatus does not add ions to the water stream, but rather removes at least some of the ions from the input flow and discharges them into the non-permeate output flow. Various different nanofiltration filter elements are suitable for use with the invention, including filter elements that contain a positively charged membrane, because such membranes generally repel the positive divalent hardness ions and limit there passage through the membrane.

The water softener of the present invention is generally designed to provide high quality water softening on the small scale needed for residential (and similar) applications. The water softener normally provides sufficient water flow such that it is not necessary to have a reservoir or pressure tank containing softened and stored water. Therefore the water softener normally provides adequate instantaneous water softening to meet the needs of a typical household. Avoiding the use of storage tanks is beneficial to consumers because it lessons the likelihood of contamination in the storage tank by microorganisms. In addition, avoiding the use of a holding tank reduces the size and cost of the water softening device. However, in some applications a container for holding at least some softened water to meet peak water demands is used.

Various pre-filters are also suitable for use with the invention in order to improve the performance and longevity of the nanofiltration element. For example, a pre-filter can be used to remove large suspended material that would otherwise clog the nanofiltration filter element. Other pre-filters suitable for use with the invention are iron pre-filters to remove iron from the input water source, sediment pre-filters to remove sediment from the input water source, chlorine pre-filters to remove chlorine from the input water source, and biological pre-filters to remove bacteria, protozoa, and other microorganisms.

In addition to using pre-filters, the water can be pretreated to improve performance by either heating the water sufficiently to improve flow rates without causing scaling, or by magnetically pretreating the input water to inhibit scaling. Other pretreatment steps, such as chemical pretreatment, are suitable for use with implementations of the invention.

In general the water softened in the present invention is potable water, such as that provided from a groundwater source. For example, the water can be from a private residential well, from a municipal water supply (typically containing groundwater), or other source. Although the supplied water is usually potable, it is possible to use non-potable water in specific implementations by providing pre-filters that remove contaminants (such as cryptosporidium).

The water softener of the invention is normally sized so that it can be placed in a space equal to or smaller than the space required for a conventional ion-exchange water softener. This allows the softening device to be used as a replacement for existing softeners. In certain implementations the softener of the invention is constructed such that it is significantly smaller than ion exchange softeners of similar softening capacity. Such savings in size are possible because it is not necessary to have ion exchange media or a recharge tank.

As discussed above, water softeners of the present invention are typically constructed and arranged so that they can be operated at relatively low pressures, generally below 250 psig. This low pressure avoids the use of expensive pressurization equipment. Specific embodiments of the invention provide an apparatus configured and arranged to have an output flow of permeate water of 200 gallons or more per 24-hour period. In general the apparatus can have a peak output flow rate of permeate water that is less than 10 gallons per minute, even more generally a peak output flow rate of permeate water that is from 5 to 10 gallons per minute. The softening apparatus is also generally highly efficient, and able to produce an output flow of permeate water containing greater than 80 percent of the input flow. In certain embodiments the output flow of permeate water contains greater than 90 percent of the input flow. The output flow of permeate water generally can have, for example, a hardness below 1.5 grains per gallon.

In certain embodiments the function of the membrane element is improved by reversing the flow between the membrane elements and flushing the concentrate by the feed, resulting in improved performance and reduced fouling behavior, thereby helping to maintain a sustainable flux.

Embodiments of the invention are also directed to regeneration of nanofiltration softening elements by flushing the membranes with an acidic solution to dissolve calcium and magnesium precipitates. The acid rinse is typically performed while the nanofiltration system is not functioning to soften water for end use, and thus it is desirable to schedule any acid rinse function for hours when water usage is low, such as late at night. Also, in general the nanofiltration elements to be flushed are readily isolated from the rest of the water system so that the acid may be flushed through the nanofiltration elements in a closed loop that does not deliver acidic water to the end user. Instead, after flushing the acid through the nanofiltration elements the acidic water can be discharged through a waste water line, typically the same line that carries the concentrate from the final nanofiltration element.

The acids used to regenerate the nanofiltration element are desirably Food and Drug Administration (FDA) approved for human consumption and are food-grade. Suitable acids include, for example, acetic acid, muriatic acid, and lactic acid, and combinations thereof. Other suitable acids include phosphoric acid, citric acid, nitric acid, sulphuric acid etc. Desirable mixtures include, for example, from 2 to 3 percent acetic acid, from 3 to 5 percent muriatic acid, and from 0.05 to 0.1 percent lactic acid.

Suitable pH levels include, for example, a pH of from 2 to 2.5. Acceptable pH levels is often below 6.0, typically below 5.0, can be below 4.0, and are below 3.0 in some implementations. The acid solution can be more effective at elevated temperatures, and thus the system also can include a heater to warm the acid solution before directing it through the nanofiltration elements. Suitable temperatures for the acid flush are, for example, above 25° C., above 30° C., above 40° C., and below 50° C. Similarly, temperature ranges of 25 to 45° C. can be used, as can temperatures of 30° C. to 40° C., and temperatures of 40 to 45° C.

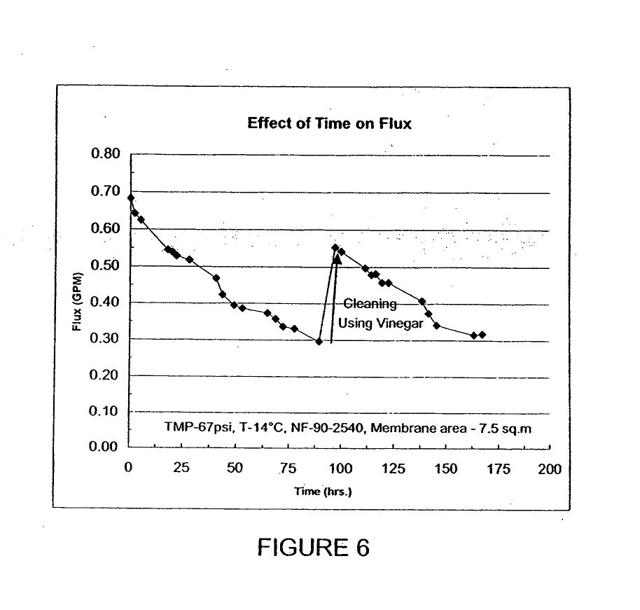

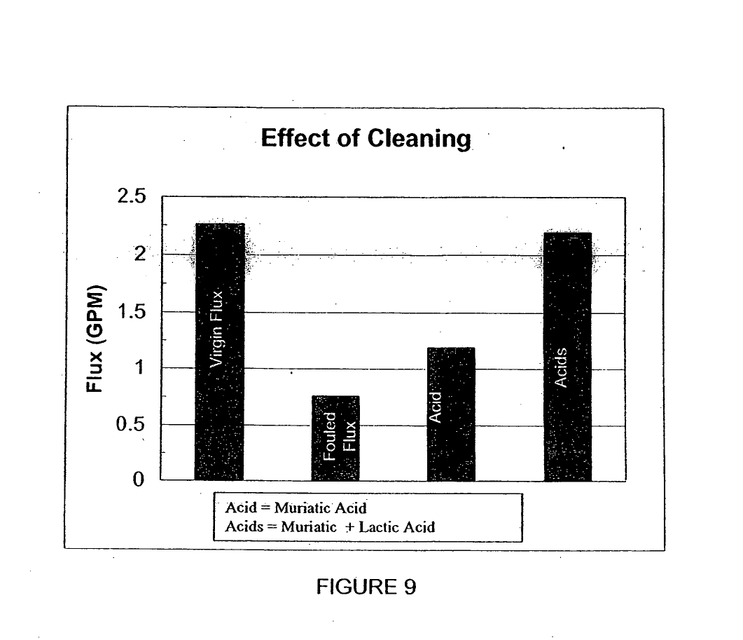

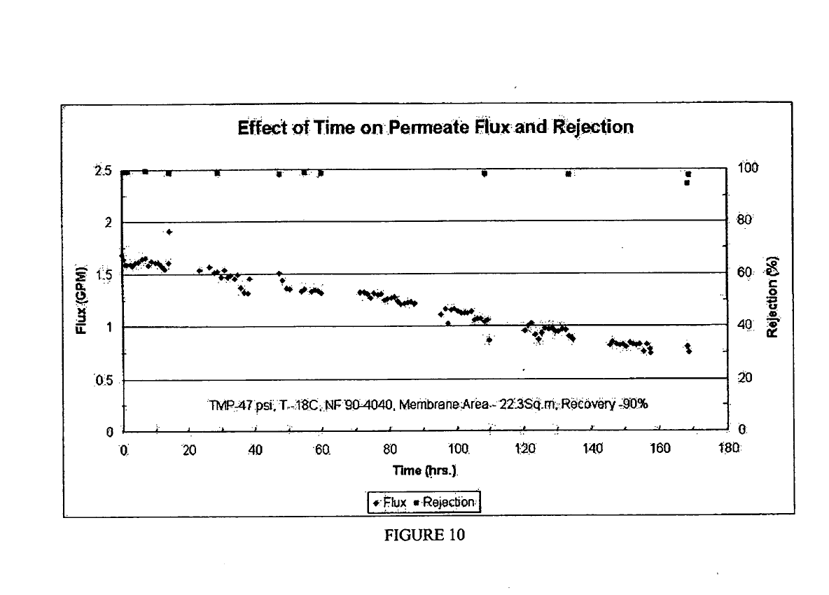

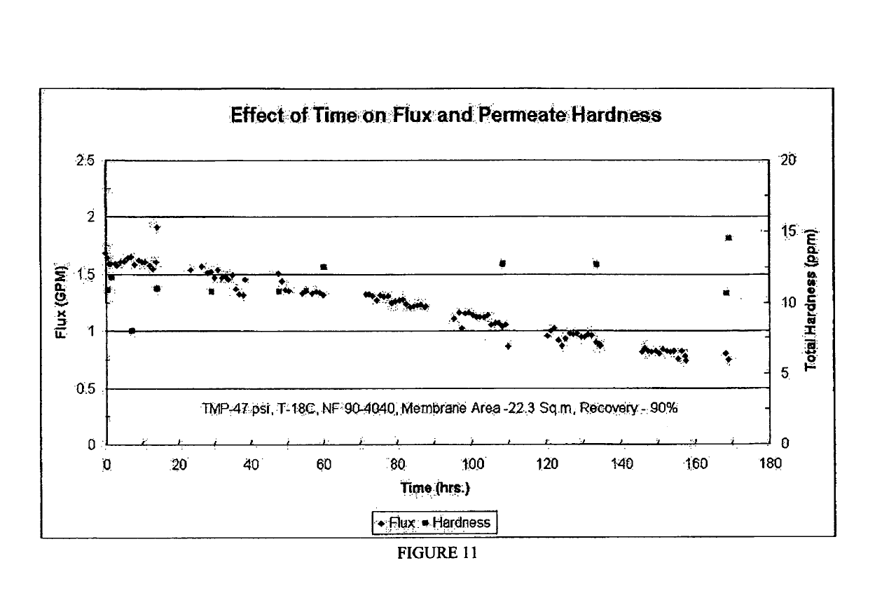

FIG. 6 shows the effect of using an acid rinse through the nanofiltration membranes to promote increased flux from the nanofiltration elements. The experiments shown in FIGS. 9, 10 and 11 were undertaken using a Dow Film Tec NF904040 membrane, with a membrane area of approximately 22.3 square meters. Municipal feed water from Savage, Minn. was processed at a pressure of 47 psi and a temperature of 18 degrees Celsius. The membrane had an original D.I. water flux of 2.25 gallons per minute, but after use for a period of 160 hours, in which 14,250 gallons of water was softened, the membrane had fouled to a point that its flux had diminished to approximately 0.75 gallons per minute. By washing the fouled membrane with 10 gallons of water containing 3-5 percent muriatic acid solution for a period of 30-45 minutes, the flux was increased to 1.25 gallons per minute. By washing the fouled membrane with 10 gallons of a 3-5 percent muriatic acid solution along with 0.05-0.1% lactic acid for a period of 30-45 minutes, the D.I. water flux was increased to 2.2 gallons per minute. FIG. 10 shows the effect of time on permeate flux and rejection demonstrating that even with a decrease in flux over time, rejection remains above 95%, and FIG. 11 shows the effect of time on permeate flux and hardness demonstrating that even with a decrease in flux over time, total permeate hardness remains below about 15 ppm. Both FIGS. 10 and 11 demonstrate that embodiments of the present invention are particularly suited for extended softening applications

In some embodiments the nanofiltration membranes are flushed every 100 hours for a period of 5 minutes with an acidic solution having a pH of 4 to 4.5 at a temperature of at least 30° C. In other implementations, the nanofiltration membranes are flushed every 100 hours for a period of 5 minutes with an acidic solution having a pH of 3 to 3.5 at a temperature of at least 25° C. In yet other implementations, the nanofiltration membranes are flushed every 100 hours for a period of 5 minutes with an acidic solution having a pH of 2 to 2.5 at a temperature of at least 20° C.

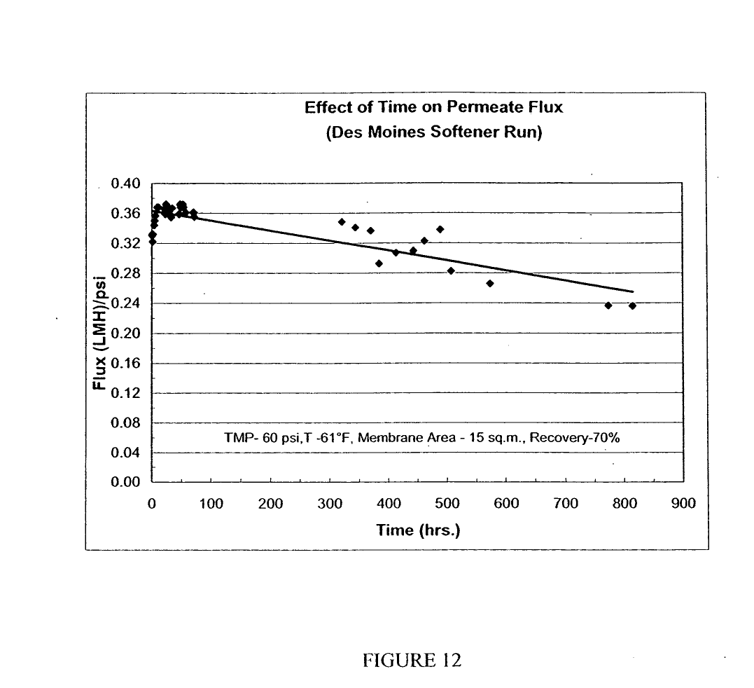

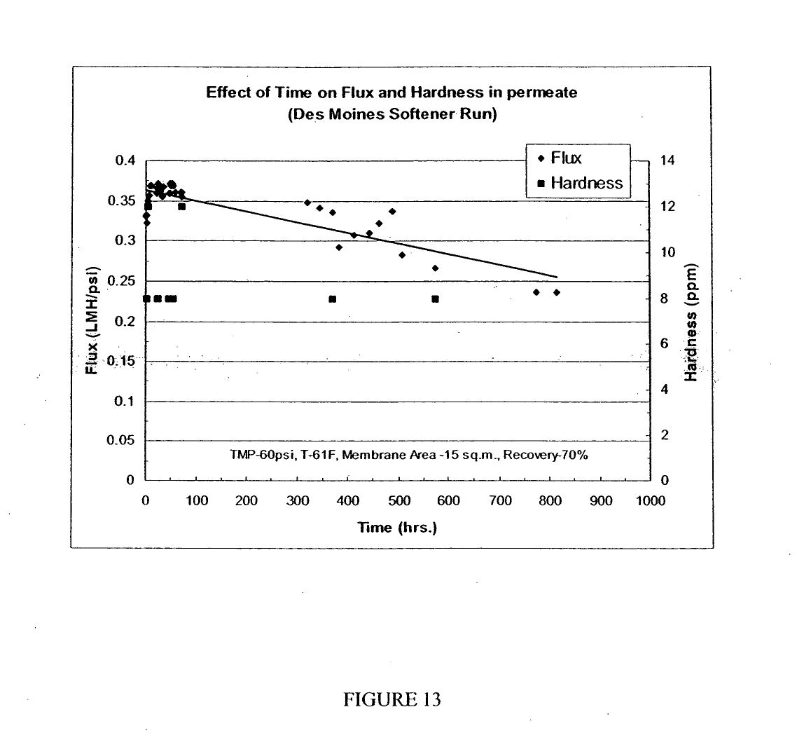

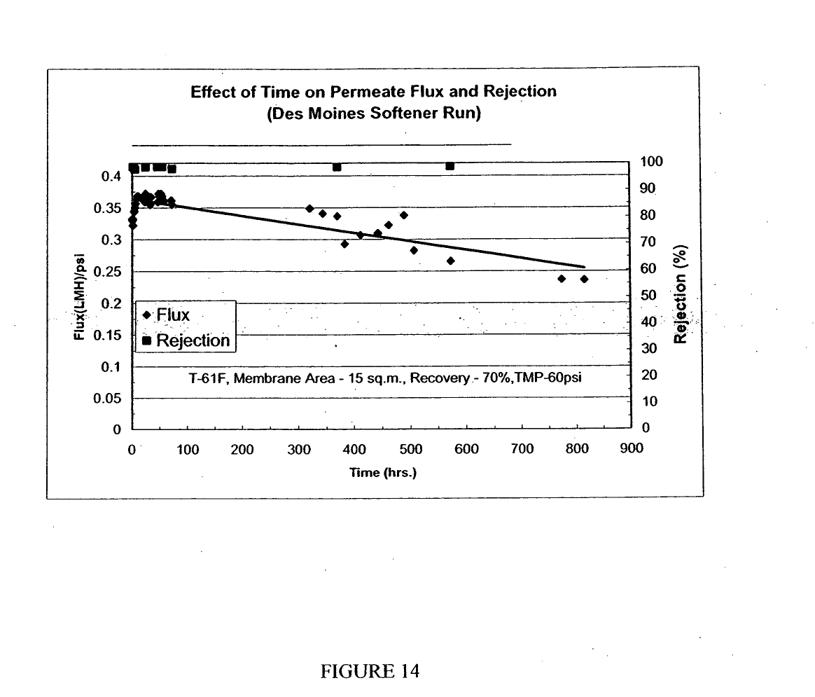

In another embodiment of the present invention, a method and apparatus are provided to remove hardness from boiler feed water for the effective long term use of the boiler. By minimizing the hardness of the boiler feed water, the life of the boiler can be extended and the energy costs and chemical treatment costs to operate the boiler can be reduced. The present embodiment employs the use of any one or combination of the previous embodiments for the treatment of the boiler feed water. In addition, prior to nanofiltration as described above, the boiler feed water may be pretreated using carbon or other filters or other treatment methods known in the art depending on the makeup of the input boiler feed water. Referring to FIG. 12, the effect of time on permeate flux is shown. As can be seen in FIG. 12, after extended use, more than 800 hours of non stop operation, flux has decreased by 33%. Upon treatment with a mineral acid or similar the original flux can be restored. Referring to FIG. 13, the effect of time on permeate flux and hardness is shown. As can be seen in FIG. 13, after extended use, more than 800 hours of non-stop operation, hardness remains below about 8 ppm, indicating the applicability of the present method and apparatus for boiler feed water applications. Referring to FIG. 14, the effect of time on permeate flux and rejection is shown. As can be seen in FIG. 14, after extended use, more than 800 hours of non-stop operation, rejection remains above about 95%, again indicating the applicability of the present method and apparatus for boiler feed water applications.

Other embodiments of the invention will be apparent to those skilled in the art from consideration of the specification and practice of the invention disclosed herein. It is intended that the specification be considered as exemplary only, with a full scope and spirit of the invention being indicated by the following claims.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

We claim:

1. A method for softening water, the method comprising:
(i) providing at least a first nanofiltration element;
(ii) providing at least a second nanofiltration element configured, said second nanofiltration element in series with the first nanofiltration element;
(iii) providing a source of potable water;
(iv) passing the potable water
a) first through the first nanofiltration element for a first period of time to generate a first permeate stream of softened water having a lower hardness than the source of potable water and a first concentrate stream of water having a higher hardness than the source of potable water, and
b) subsequently passing the first concentrate stream through the second nanofiltration element to generate a second permeate stream of softened water having a lower hardness than the source of potable water and a second concentrate stream of water having a higher hardness than the source of potable water;
(v) reversing the flow of the potable water such potable water from the source of potable water passes:
a) first through the second nanofiltration element for a second period of time to generate a permeate stream of softened water having a lower hardness than the source of potable water and a concentrate stream of water having a higher hardness than the source of potable water, and
b) Subsequently passing the concentrate stream through the first nanofiltration element to generate a permeate stream of softened water having a lower hardness than the source of potable water; and
repeating steps (iv) and (v).

2. The method for softening water of claim 1, wherein the first nanofiltration element is configured to reject at least 80 percent of calcium ions.

3. The method for softening water of claim 1, wherein the first nanofiltration element is configured to reject at least 80 percent of calcium ions.

4. The method of claim 1, further comprising a third nanofiltration element intermediate the first and second nanofiltration elements.

5. The method of claim 1, wherein the first period is less than 2 hours in duration.

6. The method of claim 1, wherein the first period is less than 1 hour in duration.

7. The method of claim 1, wherein the first period is less than 30 minutes in duration.

8. The method of claim 1, wherein the first period is at least 10 minutes in duration.

9. The method of claim 1, wherein the second period is less than 2 hours in duration.

10. The method of claim 1, wherein the second period is less than 1 hour in duration.

11. The method of claim 1, wherein the second period is less than 30 minutes in duration.

12. The method of claim 1, wherein the second period is at least 10 minutes in duration.

13. The method of claim 1, further comprising purging the nanofiltration filter elements for a period of at least 30 seconds.

14. The method of claim 1, further comprising purging the nanofiltration elements for a period of less than 5 minutes.

15. The method of claim 1, further comprising purging the nanofiltration elements for a period of time less than 10 percent of the softening period.

16. The method of claim 1, further comprising purging the nanofiltration elements for a period of time less than 5 percent of the softening period.

17. The method of claim 1, further comprising purging the system with an acid composition

18. The method of claim 1, wherein the acid is selected from the group consisting of muriatic acid, acetic acid, lactic acid, and combinations thereof.

19. The method of claim 1, wherein the acid is selected from the group consisting of phosphoric acid, sulphuric acid, citric acid, and combinations thereof.

20. A method for softening water, the method comprising:
(i) providing a first nanofiltration element configured to reject at least 80 percent of calcium ions;
(ii) providing a second nanofiltration element configured to reject at least 80 percent of calcium ions, said second nanofiltration element in series with the first nanofiltration element;
(iii) providing a source of potable water;
(iv) passing the potable water through the first nanofiltration element and then into the second nanofiltration element for a first period of time;
(v) reversing flow of the potable water such that it passes through the second nanofiltration element and then into the first nanofiltration element for a second period of time, wherein the second period of time is shorter than the first period of time.
repeating steps (iv) and (v) during performance of the method.

21. The method of claim 20, further comprising a third filtration element, said third filtration element positioned intermediate the first and second element such that flow between said first and second elements passes through the third element.

22. The method of claim 20, wherein the first period of time is from 20 to 30 minutes, and the second period of time is from 20 to 30 minutes.

23. The method of claim 20, further comprising the addition of acid

24. The method for softening water in accordance with claim 20, wherein the input flow is provided at a pressure of 10 to 200 pounds per square inch.

25. The method for softening water in accordance with claim 20, wherein the input flow is provided at a pressure of 25 to 50 pounds per square inch.
